(19) United States
(12) Patent Application Publication
(10) Pub. No.: US 2026/0070112 A1
(43) Pub. Date: Mar. 12, 2026

(54) TILED BACKING MAT SYSTEM FOR AN INCREMENTAL SHEET FORMING SYSTEM WITH RESILIENT TOOLING

(71) Applicant: FIGUR MACHINE TOOLS LLC, Boonton, NJ (US)

(72) Inventor: Justin Michael Nardone, Mountain Lakes, NJ (US)

(21) Appl. No.: 19/108,889

(22) PCT Filed: Sep. 7, 2023
(86) PCT No.: PCT/US2023/032147

§ 371 Date: Mar. 5, 2025

Related U.S. Application Data
(60) Provisional application No. 63/404,348, filed on Sep. 7, 2022.

(51) Int. Cl. B21D 31/00

(52) U.S. Cl. CPC B21D 31/005

(57) ABSTRACT

A resilient compressible tiled backing mat system used in an Incremental Sheet Forming (ISF) System, the ISF system having a primary rigid forming tool assembly and a backing flat tool assembly including a flat rigid plate for releasably holding the tiled backing mat that is compressed in response to force provided through a work piece by the primary forming tool. The tiled backing mat includes a plurality of individual tiles arrayed in a packed or nested pattern and being releasably secured to the flat rigid plate via a magnetic layer of the tiles. Individual tiles are easily replaced if damaged or worn without replacing the entire mat. Tiled backing mat configurations can be sized according to the area of the flat rigid plated and/or the particular machine area required for forming a selected work piece.

### CROSS-REFERENCE TO RELATED APPLICATIONS

This application is related to U.S. Provisional Patent Application No. 62/844,177, entitled “Incremental Sheet Forming System with Resilient Tooling,” filed May 7, 2019, and U.S. Provisional Patent Application No. 63/006,802, entitled “Incremental Sheet Forming System with Resilient Tooling,” filed Apr. 8, 2020. This application is also related to U.S. patent application Ser. No. 16/866,172, entitled “Incremental Sheet Forming System with Resilient Tooling,” filed on May 4, 2020, and issuing as U.S. Pat. No. 11,440,073 on Sep. 13, 2022, and to U.S. patent application Ser. No. 17/881,003, entitled “Incremental Sheet Forming System with Resilient Tooling,” filed on Aug. 4, 2022. Furthermore, this application claims priority to U.S. Provisional Application No. 63/404,348, filed Sep. 7, 2022.

### FIELD OF THE INVENTION

The present invention relates to an apparatus for incrementally forming sheet materials such as sheet metal.

### BACKGROUND OF THE INVENTION

Numerous methods for forming sheet materials (typically metal sheets) into complex shapes have been developed over the years. Sheet forming technologies exist across a wide range of industries and apply to a variety of metals and plastics. Typical high-volume production of sheet metal parts utilizes stamping technology. Stamping requires the use of two rigid dies that are machined with high levels of accuracy. A sheet of material (i.e., work piece) is pressed between the two dies to form the material into the desired configuration as established by the dies.

Another technique for forming sheet materials is called Incremental Sheet Forming (ISF) in which at any time only a small portion of the sheet metal is actually being incrementally configured by formation. Emmens et al., “The Technology of Incremental Sheet Forming—A brief review of the history”, Journal of Materials Processing Technology (2010) and Jeswiet et al., Asymmetric Single Point Incremental Forming of Sheet Metal. CIRP Annals—Manufacturing Technology 54 (2): 88-114 (December 2005).

ISF systems not only provide flexibility over prior forming systems by removing the long lead times and need for producing and using expensive dies to form complex sheet metal parts, but additionally localize the forming forces on the work piece so as to control precisely and locally the stress that occurs during formation of the sheet material.

Two Point Incremental Forming (TIP), also known as dual sided incremental forming, is a variation of ISF in which sheet material generally is clamped at its outer edges and force is applied from each side of the sheet material. There, however, remains the difficulty in precisely controlling the opposed tool positioning during the formation process leading to defects such as wrinkles and tearing in the resulting work piece configuration.

In U.S. Pat. No. 11,440,073 (Nardone) ('073 Patent), an improved dual sided ISF system is described that in at least one embodiment includes a primary forming tool assembly 10 and a backing flat tool assembly 30. A work piece 80, consisting of a sheet material, is positioned between the opposed tools. Backing flat tool assembly 30 includes a flexible resilient surface material layer 32 that is affixed to a rigid plate 31 with an adhesive, a retainer such as clamps, or another suitable attachment method know in the art. Material layer 32 preferably comprises a preformed sheet of resilient material that faces the lower surface of work piece 80 (See for example FIGS. 4 and 5 of the '073 Patent).

Within a work area, primary rigid tool assembly 10 as described in the '073 Patent applies force to one surface of the sheet material while backing flat tool assembly 30 applies a controlled counter force to the opposite surface of the sheet material. This dual sided process localizes the forces on the sheet material in an area of contact on the work piece between the opposed tools (rather than the broadly applied forces and resulting overall stresses exerted upon the entire sheet material while using only a rigid tool on one side of the sheet material).

From practicing the above embodiment of the '073 Patent, it has been found that continuous use of this ISF system causes material layer 32 to “wear out,” particularly toward the approximate center of the work piece area. As a result, from time to time, resilient layer 32 should be replaced to retain a flexible, compressible, and resilient surface material layer.

### SUMMARY

In operating ISF systems having a backing flat tool assembly such as described in the '073 Patent. Applicant discovered that portions of its flexible, resilient surface material layer 32 could be subjected to wear, thereby degrading performance of the material layer in maintaining a force concentration within a small zone of contact between its primary forming tool assembly, backing flat tool assembly, and work piece.

The present invention describes a system for readily replacing flexible resilient surface material 32 of the '073 ISF system, as needed, by incorporating a tiled backing mat or matrix into its backing flat tool assembly. The tiled backing mat may include a plurality of individual tiles 33 arrayed in a packed or nested pattern (joined together edge-to-edge) that substantially eliminates gaps between adjacent tiles. The individual tiles can be releasably secured to a flat rigid ferrous metallic plate of the backing flat tool assembly via a magnetic layer of the tiled backing mat, and can be readably removed from the rigid plate and replaced if damaged or worn, without the need to replace the entire mat or matrix. The backing mat can be configured and dimensioned according to the particular size of the work area needed or of the flat rigid plate when during ISF system operations, a specific sized tile or tiles may be required for forming a selected work piece.

In accordance with an aspect of the present invention, a planar tile is described for use within a backing mat of a machine tool assembly such as an ISF system having a planar, ferrous metallic rigid plate used in the forming process. The resilient tile comprises a first material layer having a planar, upper compressible and resilient material surface and a lower planar surface, and a second material layer having planar, upper, and lower surfaces, with at least the lower surface being magnetic. The tile preferably comprises a third layer for permanently adhering the lower planar surface of the first layer to the upper planar surface of second layer. The lower magnetic layer of the second material layer is releasably secured to the rigid plate of the machine tool. Moreover, the magnetic surface layer has a magnetic strength such that the tiles remain secured to the flat rigid plate without slippage when the machine tool is in operation, yet the tile is removable from the flat plate when the ISF system in not in operation.

In accordance with an additional aspect of the present invention, a planar tile includes the components described above, and further comprises a third planar stiffening material layer having upper and lower surfaces, the stiffening material layer positioned between the lower surface of the first material layer and the upper surface of the second material layer. The tile also preferably includes a fourth layer for permanently adhering the lower planar surface of the first material layer to the upper surface of the stiffening material layer and a fifth layer for permanently adhering the lower surface of the stiffening layer to the upper surface of the second material layer.

In another aspect of the present invention, edges or sides of an individual tile are configured and dimensioned as a polygon, and the polygon shape preferably is that of a hexagon with equal edge dimensions.

In another aspect of the present invention, a plurality of the planar tiles are of the same size and configuration and are arranged and joined together as a backing mat in which the tiles are replaceable and arranged together in a packed or nested configuration. The tiles may optionally in addition include interlocking features to further secure the edges of adjacent tiles to one another (for example, using features similar to the tabs and blanks that interlock adjacent jigsaw puzzle pieces).

In another aspect of the present invention, there is described a backing mat that includes a plurality of individual tiles as configured and dimensioned above in which the tiles are replaceable arranged together in an edge-to-edge, packed or nested configuration to form a matrix.

In another aspect of this invention, a planar tile is described for use in an incremental sheet forming (ISF) system including a primary forming tool assembly positioned opposite a backing flat tool assembly having a flat, ferrous metallic surface plate. The tile comprises an upper flexible resilient surface material layer and a lower securing magnetic layer. The lower magnetic layer has a magnetic strength to remain secured to the flat rigid plate without slippage when the ISF system is operated, yet can be removed from the flat plate when the ISF system is not in operation. Preferably, an adhesive layer permanently affixes the upper resilient layer to the lower magnetic layer. The resulting tile is configured and dimensioned to form a hexagon with equal edge dimensions.

As seen will be in FIG. 3A, an individual tile 333 may for example include an upper flexible resilient surface material layer 332 and a lower securing layer 334 (preferably magnetic) that are permanently secured together by an adhesive layer 335. Alternatively, as seen in FIG. 4A, an individual tile 433 may also include a flat stiffening layer 438, that is positioned between an upper flexible resilient surface material layer 432 and a lower securing layer 434 (preferably magnetic). Upper resilient layer 432 can be permanently affixed to stiffening layer 438 by adhesive layer 435, and lower securing layer 434 can be permanently affixed to stiffening layer 438 by adhesive layer 437.

As will be seen in FIGS. 5A-B and 6A, individual tiles, such as 533, are joined together in a packed or nested configuration to form a tiled backing mat or matrix 536 or 636.

As will be seen in FIGS. 1A-B, 5, and 6A, a backing flat tool assembly 30 comprises tiled backing mat 36, 536 or 636 and a flat rigid plate 31 or 631. The backing mat is preferably releasably and magnetically secured to the flat ferrous metallic rigid plate.

As will be seen more specifically below, when operating ISF systems having a backing flat tool assembly 30 (See e.g., FIGS. 1A-B and 2) Applicant discovered that portions of a resilient surface material layer 32 could be subjected to wear, thereby degrading performance of resilient surface material layer 32 in maintaining a force concentration within a “zone of contact” on a work piece 80 originating from a primary forming tool 10. To be able to remove and replace only the generally worn-out portion of the resilient material layer 32, Applicant has invented a novel tiled backing mat assembly 30 that includes not only outer resilient material layer 32 but also a multitude of specifically shaped individual laminated tiles 33 that pack or nest together to create a tiled backing matrix or mat 36 releasably secured to rigid plate 31 of backing flat mat assembly 30. (See FIGS. 1A-B, 2, 5A, 5B, and 6A). These tiles 33 are individually secured to the ISF system when the machine is operating yet, releasable from the ISF system when the ISF system in not operating. As a result, worn-out tiles can be readily and quickly removed and replaced to maintain high performance of the ISF system.

As will be seen in further detail below, FIGS. 1A-B depict an embodiment of an ISF sheet forming apparatus For use in conjunction with the inventive tiled backing mat. This embodiment is a 3-tier assembly comprising sheet fixture assembly 60, secondary forming tool assembly or backing flat tool assembly 30, and lower platform 63, that are connected and supported by a plurality of posts 64. In turn, and as seen in FIGS. 1A and 2, backing flat tool assembly 30 includes tiled backing mat 36 with outer (i.e., upper) flexible surface material layer 32. Tiled backing mat 36 is releasably secured to a flat plate 31 of backing flat tool 30. In FIG. 1A, work piece 80 is shown formed into its final shape 81. This embodiment also includes primary forming tool assembly 10 and work piece 80, that usually begins in a flat state shown in this embodiment as parallel to a reference plane. A reference plane, positioned along the X-Y axes, is defined by the initial configuration of work piece 80 prior to its incremental forming.

### BRIEF DESCRIPTION OF THE DRAWINGS

FIGS. 1A and B depict an embodiment of the present ISF system with a fixed frame assembly for holding a work piece, a primary forming tool assembly and a backing flat tool assembly. In particular:

FIG. 1A depicts an exemplary axonometric view of this embodiment; and

FIG. 1B depicts an exemplary front cross-section view of this embodiment.

FIG. 2 depicts another exemplary axonometric view of the above embodiment of FIGS. 1A-B as incorporated into a machine center.

FIGS. 3A-D depict a first laminate construction for an individual rectangular tile that is a component of a tiled backing mat in an ISF system in accordance with embodiments of the present invention. In particular:

FIG. 3A provides an exploded perspective view of the tile;

FIG. 3B presents a schematic view illustrating a first edge of the tile of FIG. 3A;

FIG. 3C presents a schematic view illustrating a second edge of the tile of FIG. 3A; and

FIG. 3D presents an enlarged cross-sectional view of the tile of FIGS. 3A-C.

FIGS. 4A-D depict a second laminate construction for an individual rectangular tile having a stiffening layer, wherein the tile becomes a component of a tiled backing mat usable in an ISF system in accordance with embodiments of the present invention. In particular:

FIG. 4A provides an exploded perspective view of the tile;

FIG. 4B presents a schematic view illustrating a first edge of the tile of FIG. 4A;

FIG. 4C presents a schematic view illustrating a second edge of the tile of FIG. 4A; and

FIG. 4D presents an enlarged cross-sectional view of the tile of FIGS. 4A-C.

FIGS. 5A and 5B depict a group of resilient hexagonal tiles arranged to form a tiled backing mat in accordance with embodiments of the present invention. In particular:

FIG. 5A presents a perspective view of the tiled backing mat, including one hexagonal tile positioned to be joined in packed or nested pattern with other hexagonal tiles in the tiled backing mat.

FIG. 5B presents a top view of this tiled backing mat, including one hexagonal tile positioned to be joined in a packed or nested pattern with other hexagonal tiles in the tiled backing mat.

FIG. 6A presents a perspective view of the tiled backing mat of FIGS. 5A-B as positioned on a rigid plate element of a backing flat tool assembly of an ISF system incorporated into a machine center.

### DETAILED DESCRIPTION

The present invention is directed to an inventive tiled backing mat or matrix system that may be used with Incremental Sheet Forming (ISF) systems having a backing flat tool assembly and a planar work surface as described, for example, in U.S. Pat. No. 11,044,073 (Nardone) ('073 Patent). The present invention provides a novel tiled backing mat or matrix system that improves upon the characteristics and performance of the resilient backing flat tool assembly as illustrated by the '073 Patent.

Applicant's inventive tiled backing mat may include a plurality of individual tiles arrayed in a packed or nested pattern-edge-to-edge-within a work area that can be releasably secured to a flat or planar, ferrous metallic rigid plate of the backing flat tool assembly of the ISF system via a magnetic tile layer. As an advantageous result, individual tiles are readably removable yet secured to the flat rigid plate when the ISF system is in operation and are easily replaced if damaged or worn, without the need to replace the entire backing mat or matrix when the ISF system is not in operation. Mat configurations and dimensions can be sized and shaped according to the particular work area or flat rigid plate surface dimensions.

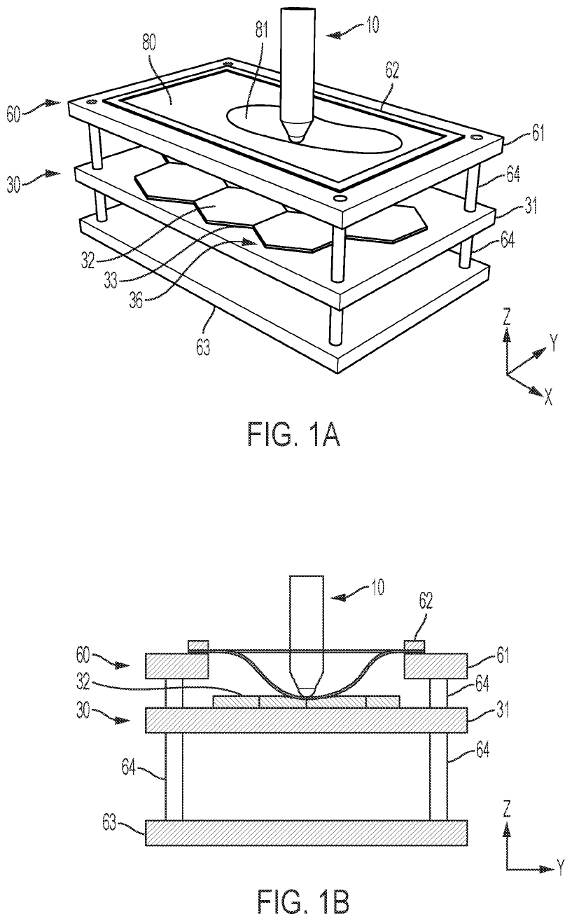

A. FIGS. 1A-B and 2-Operation of ISF System with Tiled Backing Matrix

FIGS. 1A-B depict an embodiment of an ISF sheet forming apparatus for use in conjunction with the inventive tiled backing mat. This embodiment is a 3-tier assembly comprising sheet fixture assembly 60, secondary forming tool assembly or backing flat tool assembly 30, and lower platform 63, that are connected and supported by a plurality of posts 64. In turn, and as seen in FIGS. 1A-B and 2, backing flat tool assembly 30 includes tiled backing mat 36 with outer (i.e., upper) flexible surface material layer 32. Tiled backing mat 36 is releasably secured to a flat plate 31 of backing flat tool 30. In FIG. 1A, work piece 80 is shown formed into its final shape 81. This embodiment also includes primary forming tool assembly 10. Work piece 80, usually begins in a flat state shown in this embodiment as parallel to a reference plane positioned along the X-Y axes, as defined by the initial configuration of work piece 80 prior to its incremental forming. The sheet material of work piece 80 may also be pre-formed with certain preliminary features prior to conducting additional operations.

In FIGS. 1A-B, primary forming tool assembly 10 is positioned adjacent one surface of work piece 80, and configured and dimensioned to engage the first (i.e., upper) surface of the work piece and to move in a direction parallel to the plane of work piece 80, as shown in this embodiment along the X-Y plane. Primary forming tool assembly 10 also is configured and dimensioned to move in a direction perpendicular to the X-Y reference plane, which is shown in this embodiment as the Z-axis, so as to be able to move into and out of contact with the first (i.e., upper) surface of the work piece.

Backing flat tool assembly 30 preferably includes flat ferrous metallic planar plate 31 and tiled backing mat 36, the latter having an outer flexible, compressible, resilient material layer 32 facing the second or lower surface of work piece 80. Resilient material 32 provides flexible, compressible, resilient, and controlled counter force as primary forming tool assembly 10 engages the opposite (i.e., first or upper) surface of work piece 80.

In the embodiment depicted in FIGS. 1A-B, backing flat tool assembly 30 is positioned adjacent to and facing the surface of work piece 80 that is opposite to the surface of work piece 80 that faces primary forming tool assembly 10. Thus, work piece 80 separates backing flat tool assembly 30 from primary forming tool assembly 10. Flat plate 31 of backing flat tool assembly 30 has a planar configuration that is positioned along the X-Y plane, with its surface material layer 32 of tiled backing mat 36 arranged to be in contact with lower surface of work piece 80.

The tip of primary forming tool assembly 10 and backing flat tool assembly 30 preferably are positioned directly opposite so as to face toward each other on either side of work piece 80 along the X-Y plane. Preferably, the area defined by dimensions of backing flat tool assembly 30 is approximately at least substantially the same or larger than the area primary forming assembly tool 10 is permitted to travel along the X-Y axes in a work area. As a result, backing flat tool assembly 30 remains in formable and direct contact with the second (i.e., lower) surface of work piece 80 as the primary forming toll assembly 10 engages the first (i.e., upper) surface of the work piece and moves along the X-Y plane.

In FIGS. 1A-B and 2, backing flat tool assembly 30 with flat rigid plate 31 is shown to be positioned away from and not in direct contact with work piece 80 only for illustration purposes. During operation of the apparatus, resilient layer 32 of backing mat 36 actually is positioned to face toward and be in direct engagement with the second (i.e., lower) surface of work piece 80. When primary forming tool assembly 10 engages and applies force on the first or opposite surface of the work piece 80, the result is a localized force in the area in which the primary forming tool assembly 10 contacts the work piece 80.

Primary forming tool assembly 10 and resilient layer 32 of tiled backing mat 36 are actually positioned to provide force which oppose each other at their points of contact as forming tool assembly 10 moves along the X-Y plane, with work piece 80 positioned therebetween. More specifically, primary forming tool assembly 10 and resilient layer 32 are in indirect contact through work piece 80 by virtue of the force applied to the first (i.e., upper) surface of the work piece by primary forming tool assembly 10 and the counter force applied to the opposite or second (i.e., lower) surface of work piece 80 by the controlled compression of flexible and resilient layer 32 of backing mat 36, and in turn, of backing tool flat assembly 30. The amount of counter force is controlled, for example, by the degree of hardness, thickness and resulting compressibility and resiliency of resilient layer 32 (i.e., the outer surface portion) of backing flat tool assembly 30.

Backing flat tool assembly 30 moves in a direction perpendicular to the X-Y plane, shown in this embodiment as the Z-axis. Movement along the Z-axis permits backing flat tool assembly 30 to remain in contact with work piece 80 as primary forming tool assembly 10 exerts precisely controlled opposed forces on the work piece.

The forces exerted by primary forming tool 10 are substantially concentrated at the points or “zone of contact” between primary forming tool 10, work piece 80 and resilient layer 32 of backing flat tool assembly 30. In other words, when resilient layer 32 and the lower surface of work piece 80 are in contact with each other, points of contact along a narrow contact area are created therebetween. Simultaneously, primary forming tool assembly 10 is positioned along the X-Y plane, facing the upper surface of work piece 80 and opposite the zone of contact of resilient layer 32 with the lower surface of work piece 80. At this zone of contact, the force from primary forming tool 10 that is exerted by work piece 80 on resilient surface material layer 32 (which also is in indirect contact with plate 31) advantageously remains concentrated and localized around the contact points, thus avoiding wrinkling, and tearing (e.g., perforating) of the resulting work piece 80. As a result, the apparatus of this embodiment is capable of creating numerous dimensionally complex and asymmetric configurations on work piece 80 as intended.

When primary forming tool assembly 10 moves along the Z-axis away from work piece 80, resilient surface material layer 32 substantially returns to its original or non-compressed shape as the force from the primary forming tool assembly 10 thus is removed. Similarly, when backing flat tool assembly 30 moves along the Z-axis away from work piece 80, resilient surface material layer 32 substantially returns to its original or non-compressed shape as the counter force from resilient surface material layer 32 thus is removed.

As primary forming tool assembly 10 advances along the X-Y plane and locally forms work piece 80 into the desired configuration, backing flat tool assembly 30 retreats along the Z-axis to the extent required to adjust for the movement of advancing primary forming tool assembly 10 to a next forming position. Due to its resilient nature, resilient layer 32 is selected to be capable of substantially returning to its original configuration once primary forming toll assembly 10 retreats along the Z-axis and moves to a new location along the X-Y plane.

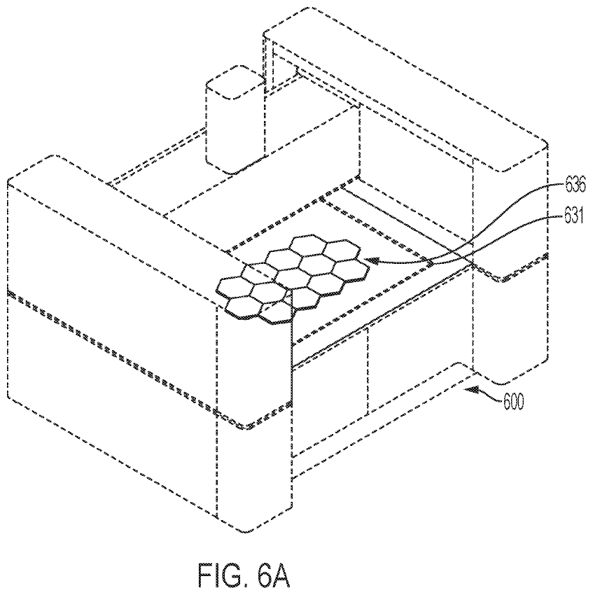

The above sequence may preferably continue until work piece 80 is fully formed into the desired configuration. (See for example FIGS. 6-10 and their accompanying descriptions of the '073 Patent.)

Resilient layer 32 of tiled backing mat 36 is preferably made of a resilient, formable material having a compression strength to enable the material to be formed under the force applied on work piece 80 by primary forming tool assembly 10. The material selected for resilient layer 32 also is capable of substantially returning to its original or non-compressed shape as the force from the primary forming tool assembly 10 onto work piece 80 is removed. For example, resilient layer 32 may be made of an elastomer, preferably polyurethane. Alternatively, it may also be made of rubber, neoprene, nitrile, or another suitable material that is capable of precise, predictable, controlled deformation and resilience when contact is made with work piece 80.

Resilient layer 32 generally has hardness durometer preferably ranging from about a Shore 10A about 80D, preferably about 30A to about 95A. Depending on the hardness of the material selected, the thickness of resilient layer 32 may vary between about 0.01 mm and about 25 mm, preferably about 1.0 mm to about 5.0 mm. By selecting a preferred durometer for resilient layer 32, a precise and controlled counter force may be applied to the second surface of work piece 80 when primary forming tool assembly 10 exerts force on the first surface of work piece 80.

Backing flat tool assembly 30 comprises tiled backing mat 36 and flat rigid plate 31. Mat 36 and its individual tiles 33 are releasably secured to the surface of plate 31. In turn, mat 36 includes outer surface material layer 32 which preferably is flat.

In operation, tiled backing mat 36 also remains removably secured to flat rigid plate 31. Rigid plate 31 of backing flat mat assembly 30 may preferably be made of steel, iron, or another suitably ferrous-containing rigid material know in the art. Plate 31 is planar and may be either solid or hollow depending on size, configuration, or weight concerns.

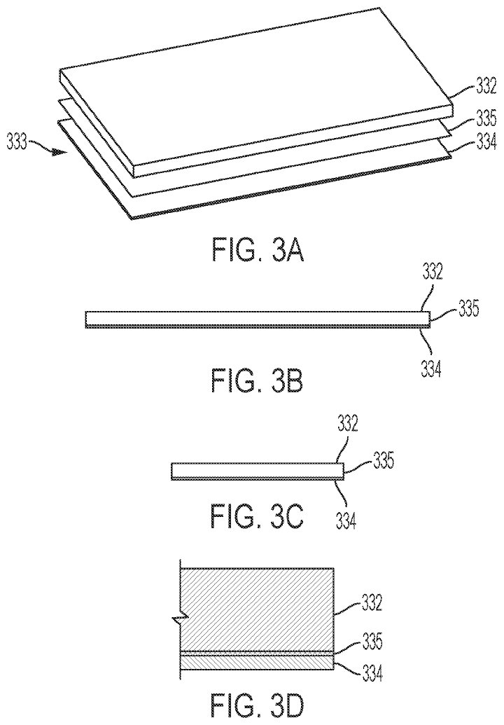

Suitable shapes, including approximate configurations and dimensions, of the multi-tilled backing mat or matrix and its individual tiles, will be discussed below with regard to FIGS. 3A-D, 4A-D, 5A-B, 6A, and Table 1.

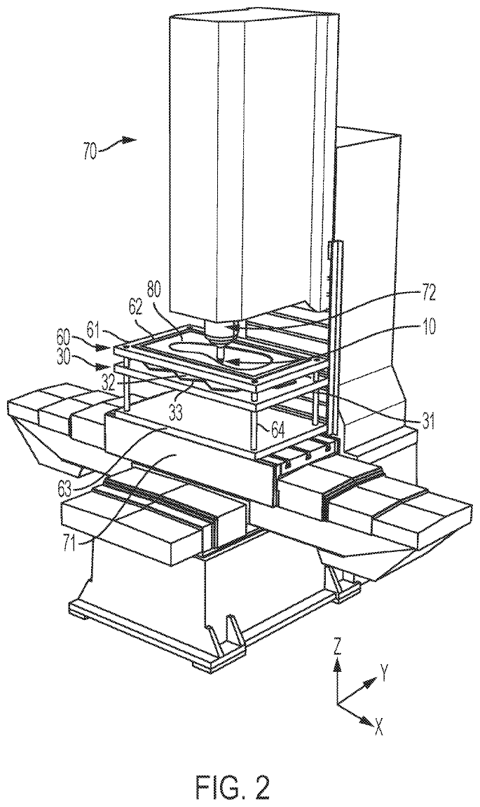

FIG. 2 illustrates an alternative mode for the operation of the embodiment of FIGS. 1A-D. In FIG. 2, this embodiment has been incorporated into a Vertical Machining Center 70 (hereinafter VMC). In this example, primary forming tool assembly 10 is inserted into spindle assembly 72 of VMC 70. Lower platform 63 is affixed to worktable assembly 71 of VMC 70.

As discussed with regard to FIGS. 1A and B, in FIG. 2, rigid frame 61 and retainer 62 of sheet fixture assembly 60 may be secured to lower platform 63 via a series of support posts 64. Backing flat tool assembly 30, which comprises rigid plate 31 and resilient layer 32 of tiled backing mat 36, is positioned between sheet fixture assembly 60 and lower platform 63. The resulting three-tiered apparatus can be controllably moved in three directions (along X, Y and Z axes) relative to primary forming tool assembly 10 via VMC 70.

By moving worktable assembly 71 in conjunction with spindle assembly 72, VMC 70 provides translational movement along three axes (X, Y and Z axes) of work piece 80 relative to the primary forming tool 10.

Alternative embodiments using other types of machining centers known in the art such as for example Horizontal Machining Centers and machining centers operational on 5-axes are possible and contemplated herein. Additional embodiments also may include incorporating primary forming tool assembly 10 and backing flat tool assembly 30 into other existing machinery in accordance with the art without departing from the principles disclosed herein.

In operating ISF systems having a backing flat tool assembly 30 (See e.g., FIGS. 1A-D and 2), Applicant discovered that portions of resilient surface material layer 32 could be subjected to wear, thereby degrading performance of resilient surface material layer 32 in maintaining a force concentration at the zone of contact as described above. FIGS. 3A-D illustrate an individual tile 333 of a first embodiment of a novel tiled backing mat for providing improved performance for ISF systems by permitting, when needed, removal and replacement of these individual tiles.

### B. FIGS. 3A-D, 4A-D, 5A-B, and 6A-Individual Tiles and Tiled Backing Mat

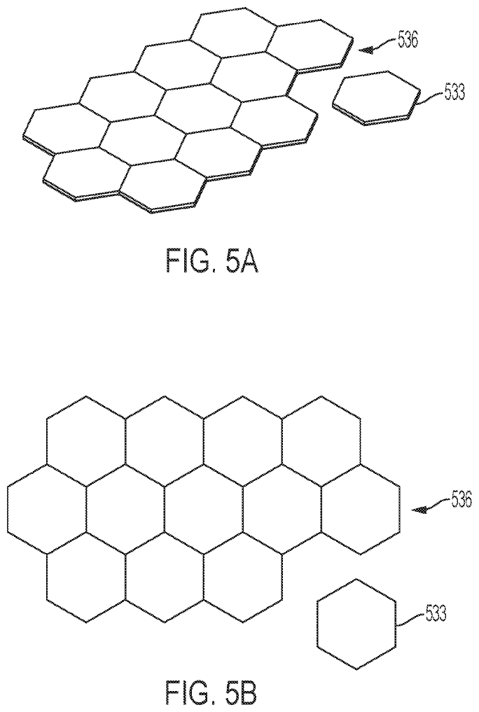

FIG. 3A provides an exploded view of a first laminate construction of an inventive individual rectangular tile 333 to be used in a field of tiles that together create a resilient and improved laminated tile backing mat (See for example tile backing mats 536 or 636 in FIGS. 5 and 6A, respectively). Specifically, rectangular tile 333 includes a resilient layer 332 (i.e., outer or upper layer) that is joined to a securing layer 334 (i.e., lower layer) by an adhesive layer 335. As described previously with regard to FIGS. 1A-B, outer resilient layer 332 may be formed, for example, as a coating or layer of polyurethane, neoprene, rubber, or another suitable material that is configured for controlled deformation when contact is made with work piece 80, and resiliently returns to its original configuration when contact is removed.

Adhesive layer 335 may be formed from an adhesive material suitable for permanently attaching outer resilient layer 332 to lower securing layer. Because rigid plate 31 (not shown in FIGS. 3A-D but See FIGS. 1A-B and 6) preferably is made from a ferrous-containing material such as iron or steel, then a sheet magnetic material is a preferred choice for lower securing layer 334. Adhesive securing layer 335 permanently secures securing layer 334 onto resilient material layer 332. Adhesive securing layer 335 may for example be formed from a double-sided sheet adhesive material, a layer of glue, or other fixed adhering materials known in the art.

FIGS. 3B-C provide a side view of the long and short edges of the rectangular tile 333, respectively, and FIG. 3D provides a cross-section through FIG. 3B to illustrate the first laminate construction in a magnified or enlarged view.

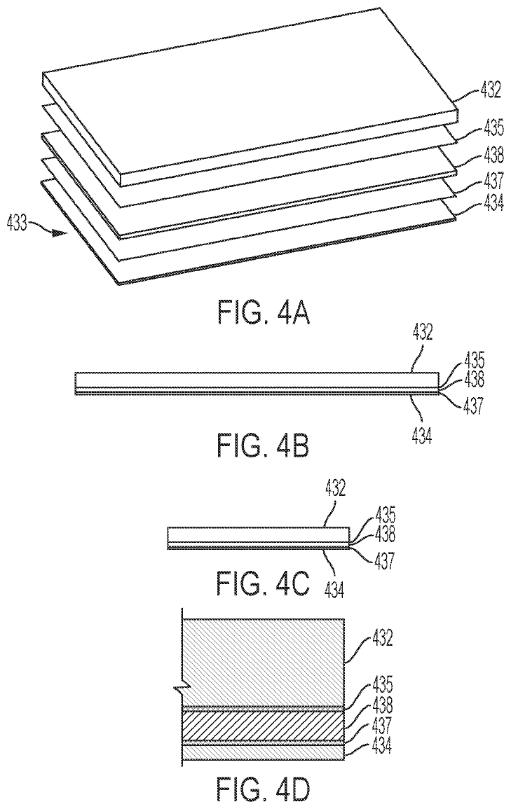

FIGS. 4A-D illustrate an individual tile 433 of a second embodiment of a novel tiled backing mat for providing improved performance in for ISF systems by permitting removal and replacement of these individual tiles. FIG. 4A provides an exploded view of this second laminate construction for individual rectangular tile 433 to be used in a field of tiles that together create a resilient and improved laminated tile backing mat (See 536 and 636 in FIGS. 5 and 6). As in the first embodiment illustrated by FIGS. 3A-D, laminated tile 433 of FIG. 4A includes an outer resilient layer 432 and a lower securing layer 434. In addition, rectangular backing tile 433 includes a stiffening layer 438 that is permanently joined to resilient layer 432 and securing layer 434 by adhesive layers 435, 437, respectively.

FIGS. 4B-C provide a side view of the long and short edges of the rectangular tile 433, respectively, and FIG. 4D provides a cross-section through FIG. 4B to illustrate the second laminate construction in a magnified or enlarged view.

Similar to that described with respect to FIGS. 3A-D, in FIGS. 4A-D, adhesive layers 435 and 437 may preferably be formed from a material suitable for permanently attaching securing layer 332 to stiffening layer 438 and lower securing layer 434 to stiffening layer 438, respectively. As flat rigid plate 31 (not shown in FIGS. 4A-D but See FIGS. 1A-B) preferably is made from a ferrous-containing material such as iron or steel, a sheet magnetic material is a preferred choice for lower securing layer 434. Adhesive securing layers 435 and 437 may be formed from a double-sided sheet adhesive material, a layer of glue, or other fixed adhering materials known in the art. Stiffening layer 438 may be formed, for example, from a ferrous or non-ferrous metal or from a rigid plastic, sized to fit within the areas defined by resilient layer 432 and lower securing layer 434.

Lower securing layers 334 and 434 of tiles 333 and 433, respectively, preferably include at least a portion that is magnetic having a sufficient magnetic strength to be fixedly secured onto flat rigid plate 31 (not shown in FIGS. 3A-d and 4A-d, see FIGS. 1A-D and 6) while the ISF is in operation, to enhance positive gripping of work piece 80 and to minimize slippage and enhancing grip with rigid plate 31. Lower securing layers 334 and 434 of tiles 333 and 433 therefore should be capable of generating a magnetic force in combination with rigid plate 31 that is sufficient to resist shear and uplift forces during forming that would result in a dislocation of one or more of tiles 333 and 433, while not so large as to inhibit removal and replacement of the tiles 333 and 433,

Tiles 333 and 433 of FIGS. 3A-D and 4A-D, respectively, may be made in accordance with procedures know in the art. Resilient layer 332 or 432 preferably comprises a preformed sheet of resilient material (as described above) that is secured by being affixed to lower securing layer 334 or stiffening layer 438, respectively.

Instead of using adhesive layer 335 or 435, one could alternatively apply a flat layer of an adhering liquid version of the aforementioned material onto the lower surface of resilient layer 332 or 432, then let the material cure in place so as to affix such layer to lower securing layer 334 or stiffening layer 438. The resulting materials may be rendered suitably flat by leveling, machining, grinding or another fabrication means.

FIGS. 5A-B provide perspective and top views, respectively, of a tiled backing mat 536 formed by laminated hexagon-shaped individual tiles 533 that are configured and dimensioned to have six edges of equal length. Applicant discovered that these hexagon-shaped tiles 533 when joined at their respective corners and edges and packed together to form mat 536 to create a particularly stable configuration.

Magnetically securing layers 334 and 434 of FIGS. 3 and 4, respectively, as positioned in tiled backing mat 536 and 636 are removably and releasably secured to rigid plate 31 of backing flat mat assembly 30. In other words, when the hexagonal tiles are constructed in accordance with FIG. 3A-D or 4A-D, the resulting magnetic laminated tiles are particularly stable and enhance positive gripping of work piece 80 by minimizing slippage of the tiles along rigid plate 31 (See FIG. 6). Moreover, the hexagon-shaped tiles pack together with each other at their corners and edges to create a matrix 536 and 636 that is secured to rigid, ferrous-containing flat plate 31, and thus improving grip of the resilient backing mat assembly 30 when operating ISF systems.

FIG. 6A further illustrates tiled backing mat 636 that is positioned on a flat rigid plate 631 of an applicable ISF system. More specifically, FIG. 6A provides a perspective view of the tiled backing mat 636 (See also 536 of FIG. 5A-B) as positioned on a rigid plate 631 of a backing flat tool assembly of an ISF system incorporated into a machine center 600. In FIG. 6A, there is illustrated a tiled backing mat 636 composed of 13 individual hexagonal tiles 533 of FIG. 5A-B, which are arranged in 3 rows, constructed in accordance with the present invention, and removably and releasably secured to flat rigid plate 631.

Although illustrated in FIGS. 5A-B and 6A (in the noted configuration of 13 individual hexagon-shaped tiles 533 and 633 arrayed in three rows), one of skill in the art will recognize that tiled backing mat 536 or 636 may alternatively include tiles arrayed in many different configurations. These configurations preferably include an array sized to fit at least a portion of flat rigid plate 631, or mats 536 and 636 that are configured to fit a specific work area or an area of flat rigid plate 631 required for forming a particular work piece.

With reference to all the FIGS, each of these packed or nested individual tiles 533 and 633 is releasably secured to flat rigid plate 31 or 631 of a backing flat mat assembly 30 via a securing lower layer 334 and 434 (e.g., a lower securing layer formed from a magnetic sheet). The packed or nested individual tiles 533 and 633 have proven to be sufficiently stable during operation of the ISF system without requiring additional means of retention to be applied at the outer edges of the tiled backing mat 536 or 636.

In accordance with another application of the present invention, Applicant has found that among the various possible shapes intended by the present invention, the hexagonal configuration for the individual tiles as seen in FIGS. 5A-B and 6A, having six 120° internal angles and six equally dimensioned edges, become particularly securely packed or nested together. Yet, when becoming “worn out,” these laminated tiles can be readily removed and releasably disengaged from each other, and as needed, replaced with new tiles. As a result of this unique joining of the magnetic hexagonal-configured individual tiles and selecting of appropriate dimensions based on the size of the work area, slippage of the multi-tile mat or matrix (e.g., along a rigid ferrous plate of an ISF tool) and the number of tiles needed for filling the desired surface are reduced from that of possible other configurations or shapes. Nevertheless, in an optional and alternative embodiment, the tiles may in addition include interlocking features to further secure the edges of adjacent tiles to one another (for example, using features similar to the tabs and blanks that interlock adjacent jigsaw puzzle pieces).

### C. Table

Certain properties of various polygonal configurations of tiles formed in accordance with aspects of the present disclosure are summarized below in Table 1.

TABLE
Characteristics of Tiles

| | | | Internal | |
|---|---|---|---|---|
| # of | | # of | Angle | |
| Edges | Shape | Angles | (degrees) | Comments |
| 3 | Triangle | 3 | 60 | Good angle degree |
| | | | | Large number of interconnecting |
| | | | | tiles required to fill desired area |
| | | | | causing high potential for slippage |
| | | | | and surface gaps between tiles. |
| 4 | Square | 4 | 90 | High potential for slippage due |
| | | | | to angles at corners of packed |
| | | | | tiles. |
| 4 | Rectangle | 4 | 90 | High potential for slippage |
| | | | | due to angles at corners of |
| | | | | packed tiles. |
| 5 | Pentagon | 5 | 108 | Uncommon angle |
| | | | | Surface gaps and high |
| | | | | potential for slippage due to |
| | | | | angles at corners of packed |
| | | | | tiles. |
| 6 | Hexagon | 6 | 120 | Good angle |
| | | | | Good tile stability with low |
| | | | | potential for slippage and no |
| | | | | corner surface gaps. |
| | | | | Good amount of area |
| | | | | coverage per tile. |
| 7 | Heptagon | 7 | 128.6 | Uncommon angle |
| | | | | Surface gaps and high |
| | | | | potential for slippage due |
| | | | | to angles at corners of |
| | | | | packed tiles. |
| 8 | Octagon | 8 | 135 | Same as rectangle/square |
| | | | | Surface gaps and high |
| | | | | potential for slippage due |
| | | | | to angles at corners of |
| | | | | packed tiles. |
| 9 | Nonagon | 9 | 140 | Uncommon angle |
| | | | | Surface gaps and high potential |
| | | | | for slippage due to angles at |
| | | | | corners of packed tiles. |

Embodiments of the inventive tiled backing mat/matrix system disclosed herein are merely exemplary and may in addition be embodied in various additional and alternative forms. The FIGs provided herein are not necessarily to scale. Some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

1. A resilient planar tile for use within a backing mat of an incremental sheet forming (ISF) system having a planar, ferrous metallic rigid plate, the resilient tile comprising:
a. a first material layer having a planar, upper compressible and resilient material surface and a lower planar surface;
b. a second material layer having planar, upper and lower surfaces, the lower surface being magnetic; and
c. a third layer for adhering the lower planar surface of the first layer to the upper planar surface of second layer;
wherein the lower magnetic layer of the second material layer is releasably secured to the rigid plate of the ISF system.

2. The planar tile of claim 1, wherein the lower surface of the second layer material comprises a magnetic sheet material.

3. The planar tile of claim 2, wherein the upper surface of the first material layer comprises a material selected from the group consisting of polyurethane, neoprene, and rubber.

4. The planar tile of claim 2, wherein edges of the tile form a polygonal shape.

5. The planar tile of claim 4, wherein the polygonal shape is a hexagon with equal edge dimensions.

6. The planar tile of claim 2, wherein said resulting resilient tile is configured and dimensioned in the shape of a planar hexagonal polygon having edges of equal length, and wherein the magnetic surface layer has a magnetic strength such that the tiles remain secured to the flat rigid plate without slippage when the machine tool is in operation yet the tile is removable from the flat plate when the ISF system in not in operation.

7. A tiled backing mat for use in an incremental sheet forming (ISF) system, the tiled backing mat comprising a plurality of planar tiles each in accordance with the planar tile of claim 4, wherein:
the plurality of tiles are of the same size and configuration; and
the plurality of tiles are arranged together in a packed configuration and configured to be releasably secured to the rigid plate of the ISF system.

8. A resilient planar tile for use within a backing mat of an incremental sheet forming (ISF) system having a planar, ferrous metallic rigid plate, the resilient tile comprising:
a. a first material layer having a planar, upper compressible and resilient material surface and a lower planar surface;
b. a second material layer having planar, upper and lower surfaces, the lower surface being magnetic;
c. a third planar stiffening material layer having upper and lower surfaces, the stiffening material layer positioned between the lower surface of the first material layer and the upper surface of the second material layer;
d. a fourth layer for permanently adhering the lower planar surface of the first material layer to the upper surface of the stiffening material layer; and
e. a fifth layer for permanently adhering the lower surface of the stiffening layer to the upper surface of the second material layer.

9. The planar tile of claim 8, wherein the lower surface of the second layer material comprises a magnetic sheet material.

10. The planar tile of claim 9, wherein the upper surface of the first material layer comprises a material selected from the group consisting of polyurethane, neoprene, and rubber.

11. The planar tile of claim 9, wherein edges of the tile form a polygonal shape.

12. The planar tile of claim 11, wherein the polygonal shape is a hexagon with equal edge dimensions.

13. A tiled backing mat for use in an incremental sheet forming (ISF) system, the tiled backing mat comprising a plurality of planar tiles each in accordance with the planar tile of claim 12, wherein:
the plurality of tiles are of the same size and configuration; and
the plurality of tiles are arranged together in a packed configuration and configured to be releasably secured to the rigid plate of the ISF system.

14. The tiled backing mat of claim 7, wherein the polygonal shape is a hexagon with equal edge dimensions.

15. The tiled backing mat of claim 13, wherein the polygonal shape is a hexagon with equal edge dimensions.

16. The tiled backing mat of claim 7, wherein one or more edges of each of the plurality tiles include an interlocking feature for securing the tile to an adjacent one of the plurality of tiles.

17. The tiled backing mat of claim 16, wherein the interlocking feature on at least one of the one or more edges of each of the plurality of tiles comprises one of a tab or blank.

18. The tiled backing mat of claim 13, wherein one or more edges of each of the plurality tiles include an interlocking feature for securing the tile to an adjacent one of the plurality of tiles.

19. The tiled backing mat of claim 18, wherein the interlocking feature on at least one of the one or more edges of each of the plurality of tiles comprises one of a tab or blank.
